(19) United States
(12) Patent Application Publication
(10) Pub. No.: US 2010/0024496 A1
(43) Pub. Date: Feb. 4, 2010

(54) Electric Locks with Release Hammer

(76) Inventors: Aron Wolfish, Tel Aviv (IL); Noam Naaman, Nesher (IL)

Correspondence Address: ARENT FOX LLP, 1050 CONNECTICUT AVENUE, N.W., SUITE 400, WASHINGTON, DC, 20036, US

(21) Appl. No.: 11/992,228

(22) PCT Filed: Dec. 9, 2006
(86) PCT No.: PCT/IL2006/001068

§ 371 Date: Oct. 8, 2009

Related U.S. Application Data
(60) Provisional application No. 60/717,634, filed on Sep. 19, 2005.

(51) Int. Cl. E05B 63/00; E05B 47/06

(52) U.S. Cl. 70/277; 70/465

(57) ABSTRACT

Electric lock with hammer for doors, locker doors, safe doors, telephone chassis, vending machines and the like which also have an anti jamming mechanism. To close the electric lock, the bar moves forward and the door latch closes upon a corresponding bolt. When moving forward, the bar stretches the spring into a tense state. The latch drops into a corresponding groove and mechanically locks the bar. To unlock the electric lock the solenoid activates the hammer while applying most of the energy over a relatively short period of time. The hammer in turn hits the latch out of its groove to unlock the electric lock. The spring pulls the bar backwards and the door latch opens up. According to the present invention, when mechanical pressure is applied upon any of lock mechanical components, the hammer strikes at the latch repeatedly until it comes out of its groove and the unlocks.

### FIELD OF THE INVENTION

The present invention relates generally to electric locks, and more particularly to electric locks devices for doors, locker doors, safe doors, telephone chassis, vending machines and the like which also have an anti jamming mechanism.

### BACKGROUND OF THE INVENTION AND PRIOR ART

Electric locking devices for doors, locker doors, safe doors, telephone chassis, vending machines and the like, often use a solenoid or a DC motor with a push/pull mechanism.

These and other lock types endure many problems when trying to open. This is usually due to mechanical pressure applied onto the latch and/or bolt which then requires high force to move said bolt and/or latch out of their locking position.

An electric hammer is designed to apply a hit of certain force, concentrated at a short period of time. Often, said force is not enough to remove the locking latch and/or bolt out of its corresponding groove and the lock is stuck.

There is therefore a need for an apparatus that will overcome the problems of a stuck electric lock, especially when a mechanical pressure is applied onto the said stuck latch and/or bolt.

### SUMMARY OF THE INVENTION

It is thus the object of the present invention to provide an apparatus with novel mechanism that, among other things, will overcome the problem of a stuck electric lock, especially when mechanical pressure is applied onto the said lock latch and/or bolt.

According to present invention an electric lock is introduced comprising: a solenoid; a hammer; a latch with a corresponding groove, wherein said solenoid, when unlocking said lock, actuates said hammer which hits said latch out of its said corresponding groove repeatedly, at preset intervals, until said latch comes out of its said corresponding groove. In normal operation one strike is enough to unlock the lock but when mechanical pressure is applied onto mechanical components of the lock, the hammer strikes will continue until said latch comes out of its said corresponding groove and the lock unlocks.

To close the electric lock, a mechanical force such as a spring, or hydraulic or pneumatic or any other force is uploaded into a loaded state. The latch drops into its corresponding groove and mechanically locks the lock.

Further objects and advantages will become apparent from a consideration of the ensuing description and drawings.

### BRIEF DESCRIPTION OF THE DRAWINGS

The present invention will become fully understood from the detailed description given herein below and the accompanying drawings, which are given by way of illustration and example only and thus not limitative of the present invention.

FIG. 1 depicts the components of an electric lock with hammer according to a first embodiment of the present invention, in a side and rear views.

FIG. 2 depicts a cam of an electric lock with hammer according to a first embodiment of the present invention.

FIG. 3 depicts a hammer of an electric lock with hammer according to a first embodiment of the present invention.

FIG. 4 depicts a latch of an electric lock with hammer according to a first embodiment of the present invention.

FIG. 5 depicts an electric lock with hammer according to a first embodiment of the present invention, in a position where the cam is pushed into place to lock the lock, against a spring force.

FIG. 6 depicts an electric lock with hammer according to a first embodiment of the present invention, in lock position.

FIG. 7 depicts an electric lock with hammer according to a first embodiment of the present invention, in a position where hammer hits the latch to come out of its corresponding groove for releasing the cam and unlocking the lock.

FIG. 8 depicts an electric lock with hammer according to a first embodiment of the present invention, in a position where the cam is mechanically turned to unlock the lock as a mechanical override.

FIG. 9 depicts the components of an electric lock with hammer according to a second embodiment of the present invention, in a side and rear views.

FIG. 10 depicts an electric lock with hammer according to a second embodiment of the present invention, in a position where the cam is pushed into place to lock the lock, against a spring force.

FIG. 11 depicts an electric lock with hammer according to a second embodiment of the present invention, in lock position.

FIG. 12 depicts an electric lock with hammer according to a second embodiment of the present invention, in a position where the hammer hits the latch to come out of its corresponding groove and unlock the lock.

FIG. 13 depicts an electric lock with hammer according to a second embodiment of the present invention, in a position where the cam is mechanically turned to unlock the lock as a mechanical override.

FIG. 14 depicts an electric lock with hammer according to a third embodiment of the present invention, in locked position.

FIG. 15 depicts an electric lock with hammer according to a third embodiment of the present invention, in unlocked position.

FIG. 16 depicts the axis rod and attached components of an electric lock with hammer according to a third embodiment of the present invention.

FIG. 17 depicts the axis rod and door of an electric lock with hammer according to a third embodiment of the present invention, just before locking position.

FIG. 18 depicts an electric lock with hammer according to a fourth embodiment of the present invention, in locked position.

FIG. 19 depicts an electric lock with hammer according to a fourth embodiment of the present invention, in unlocked position.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, methods, and examples provided herein are illustrative only and not intended to be limiting.

The present invention will become fully understood from the detailed description given herein below and the accompanying drawings, which are given by way of illustration only and thus not limitative of the present invention, and wherein.

In an embodiment of the present invention an electric lock is provided which includes a solenoid; a hammer; a latch with a corresponding groove, a cam unit, a spring and a cavity. Wherein the solenoid, when unlocking said lock, actuates the hammer which hits the latch out of its corresponding groove repeatedly, at preset intervals, until the latch comes out of its corresponding groove. At normal operation one strike is enough to unlock the lock but when mechanical pressure is applied onto mechanical components of the lock, hammer strikes will continue until the latch comes out of its corresponding groove and the lock unlocks. To close the electric lock, a mechanical force such as a spring, or hydraulic or pneumatic or any other force is uploaded into a loaded state. The latch drops into its corresponding groove and mechanically locks the lock.

In another embodiment of the present invention, an electric lock is provided comprising a hammer; solenoid; latch and corresponding groove; cam unit, spring and a cavity. The electric lock does not have a bar, but a cam with a part affixed to the door, for example. The cam is able to rotate about its axis and includes a groove. In a locking operation, the cam enters the cavity and pushes against a physical force such as a loading spring which is loaded. When the groove reaches a position opposite to the latch, the latch drops into said groove disallowing cam from going back out, and thus locking it. To unlock the electric lock with the hammer according to the second embodiment of the present invention, the plunger of the solenoid with the hammer on top activates the hammer while applying most of the energy over a relatively short period of time. The hammer in turn hits the latch out of its groove to unlock the electric lock. The spring unloads and pushes the cam backwards and the door opens up. According to the second embodiment of the present invention, when mechanical pressure is applied upon any of the mechanical components of the lock, the hammer strikes at the latch repeatedly until it comes out of its groove and the electric lock unlocks. When the latch comes out of its groove, it will also cause the circuitry to stop actuating the solenoid.

In still another embodiment of the present invention an electric lock is provided comprising a hammer; solenoid; locking latch; cam unit, springs, axis rod, and locking lever. When closing the door, the cams enter the gap of the two latches, respectively. Said latches are assembled on an axis rod along with the locking lever. When the door is pushed to lock, the latches turn the axis rod which in turn turns also the locking lever, which moves while loading the spring. When locking, the lever reaches the locking latch; it is pushed back against the spring. When locking the lever passes beyond the VAV of the locking latch, it is pushed forward by the spring; the locking latch and locking lever lock each other. The electric lock is now locked. To unlock the electric lock with a hammer according to the third embodiment of the present invention, the solenoid activates the hammer while applying most of the energy over a relatively short period of time. The hammer in turn hits the locking latch out of its locking position with the locking lever. The spring pulls the locking lever backwards and the door opens up as the axis rod turns to move the latches. According to the third embodiment of the present invention, when mechanical pressure is applied upon any of the mechanical components of the lock, the hammer strikes at the latch repeatedly until it releases the locking lever and the lock unlocks. When the locking lever unlocks, it will also cause the circuitry to stop actuating the solenoid.

In yet another embodiment of the present invention an electric lock with a hammer comprising a hammer; a solenoid, a latch and a corresponding bolt, a spring, a groove and a bar that moves forward and the door latch closes upon a corresponding bolt. When moving forward, the bar stretches the spring into a tense state. The latch drops into the groove and mechanically locks the bar. The solenoid and the hammer are not active in the locking procedure. To unlock the electric lock with the hammer according to this embodiment of the present invention, the solenoid activates the hammer while applying most of the energy over a relatively short period of time. The hammer in turn hits the latch out of its groove to unlock the electric lock. The spring unloads and pulls the bar backwards and the door latch opens up. According to the present embodiment of the invention, when mechanical pressure is applied upon any of the mechanical components of the lock, the hammer strikes at the latch repeatedly until it comes out of its groove and the lock unlocks. When the latch comes out of its groove, it will also cause the circuitry to stop actuating the solenoid. An appropriate electrical circuitry will keep the solenoid from pushing the hammer at a preset interval. The hammer will keep hitting the latch/bolt until it comes out of its groove, which will cause the circuitry to stop actuating the solenoid.

The above features, and other features and advantages of the present invention are readily apparent from the following detailed descriptions thereof when taken in connection with the accompanying drawings.

### DETAILED DESCRIPTION OF THE DRAWINGS

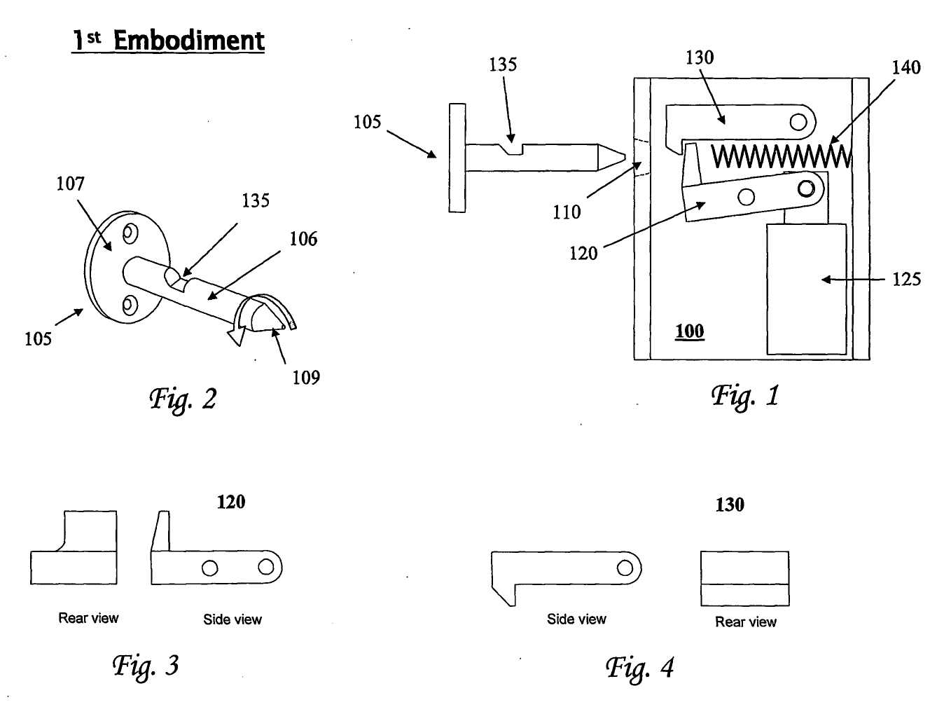

FIG. 1 depicts the components of an electric lock 100 with hammer according to a first embodiment of the present invention. This electric lock 100 comprises a hammer 120, solenoid 125, latch 130 and corresponding groove 135, cam unit 105, spring 140 and a cavity 110. Cam unit 105 is shown in FIG. 2 comprising part 107 affixed to the door, for example. The cam 106 has a groove 135, a conical end 109 and is able to rotate about its axis. Hammers 120 is shown in FIG. 3 and latch 130 is shown in FIG. 4.

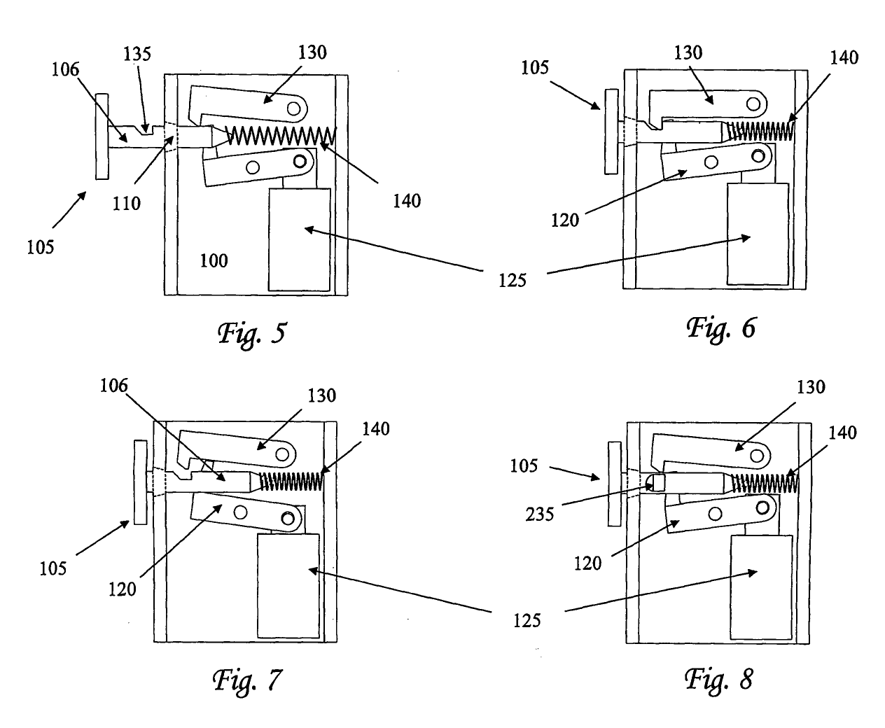

In a locking operation, illustrated in FIG. 5, cam 106 enters cavity 110 and pushes against a physical force such as a loading spring 140 which is loaded. When groove 135 reaches a position opposite to latch 130, latch 130 drops into said groove 135 disallowing cam 106 from going back out and thus locking it. The status of cam locked in place is depicted in FIG. 6.

To unlock the electric lock 100 with hammer 120 according to a first embodiment of the present invention, illustrated in FIG. 7, solenoid 125 actuates hammer 120 while providing most of the energy over a relatively short period of time. Hammer 120 in turn hits latch 130 out of its groove 135 to unlock said electric lock 100. Spring 140 unloads and pushes cam 106 backwards and door opens up. According to the present invention, when mechanical pressure is applied upon any of lock 100 mechanical components, hammer 120 strikes at latch 130 repeatedly until it comes out of its groove 135 and lock 100 unlocks. When latch 130 comes out of its groove 135, it will also cause the circuitry to stop actuating solenoid 125. The status of cam rotated and released to unlock lock 100 is depicted in FIG. 8.

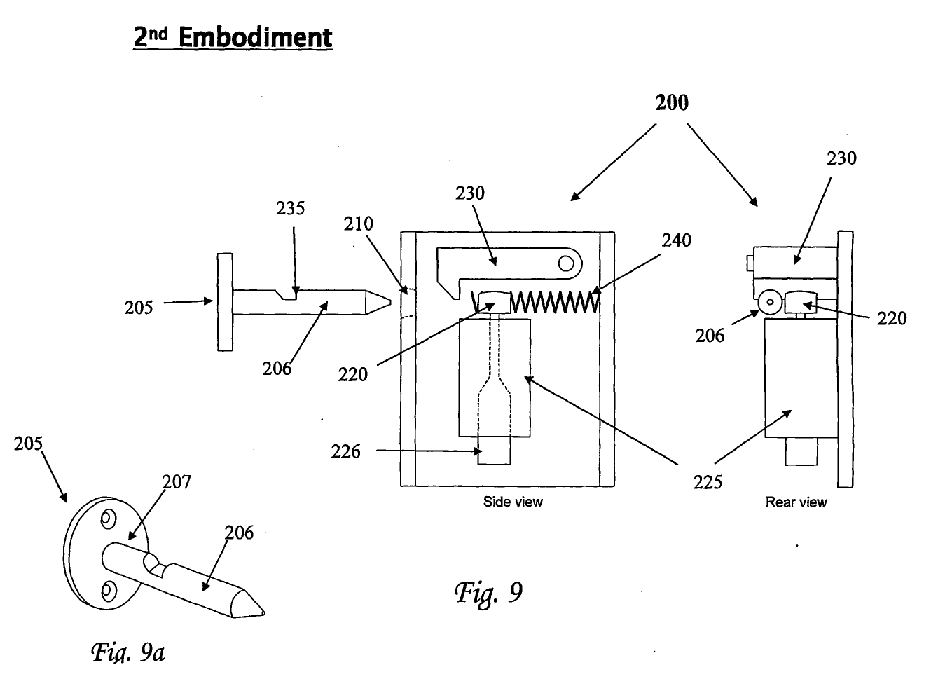

FIG. 9 depicts the components of an electric lock 200 with hammer according to a second embodiment of the present invention, in a side and rear views. In this embodiment, lock 200 comprises a hammer 220; solenoid 225; latch 230 and corresponding groove 235; cam unit 205, spring 240 and a cavity 210. Lock 200 does not have a bar, but a cam 206 with part 207 affixed to the door, for example. Cam 206 is able to rotate about its axis and includes groove 235. Cam unit 205 is shown in FIG. 9a comprising part 207 affixed to the door, for example.

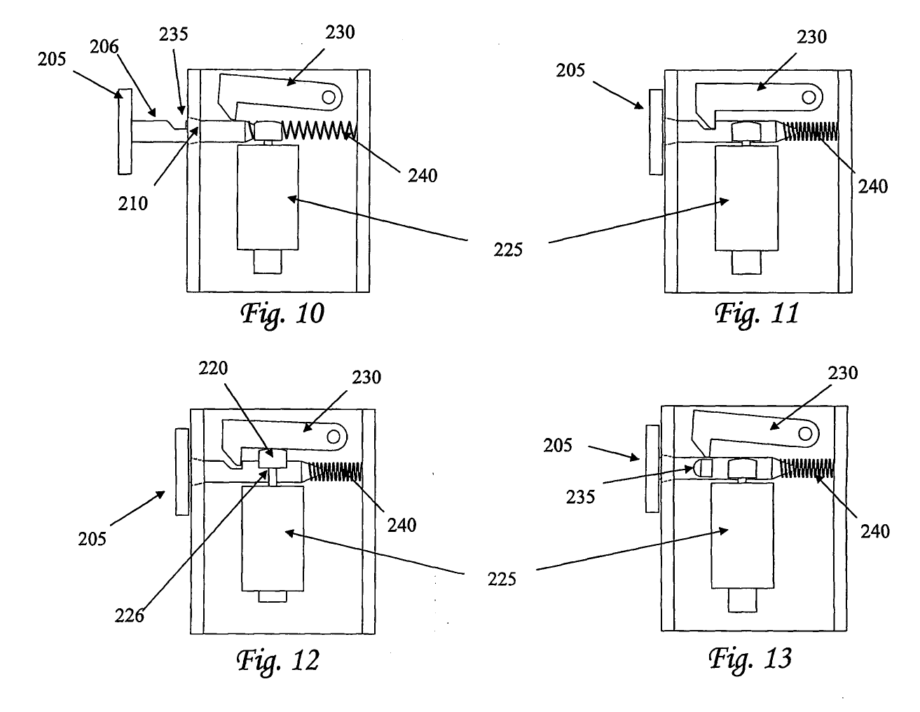

In a locking operation, illustrated in FIG. 10, cam 206 enters cavity 210 and pushes against a physical force such as a loading spring 240 which is loaded. When groove 235 reaches a position opposite to latch 230, latch 230 drops into said groove 235 disallowing cam 206 from going back out and thus locking it. This status is depicted in FIG. 11.

To unlock the electric lock 200 with hammer 220 according to a second embodiment of the present invention, illustrated in FIG. 12, plunger 226 of solenoid 225 and with hammer 220 on top, activates hammer 220 while applying most of the energy over a relatively short period of time. Hammer 220 in turn hits latch 230 out of its groove 235 to unlock said electric lock 200. Spring 240 unloads and pushes cam 206 backwards and door opens up. According to the present invention, when mechanical pressure is applied upon any of lock 200 mechanical components, the hammer 220 strikes at latch 230 repeatedly until it comes out of its groove 235 and lock 200 unlocks (FIG. 13). When latch 230 comes out of its groove 235, it will also cause the circuitry to stop actuating solenoid 225.

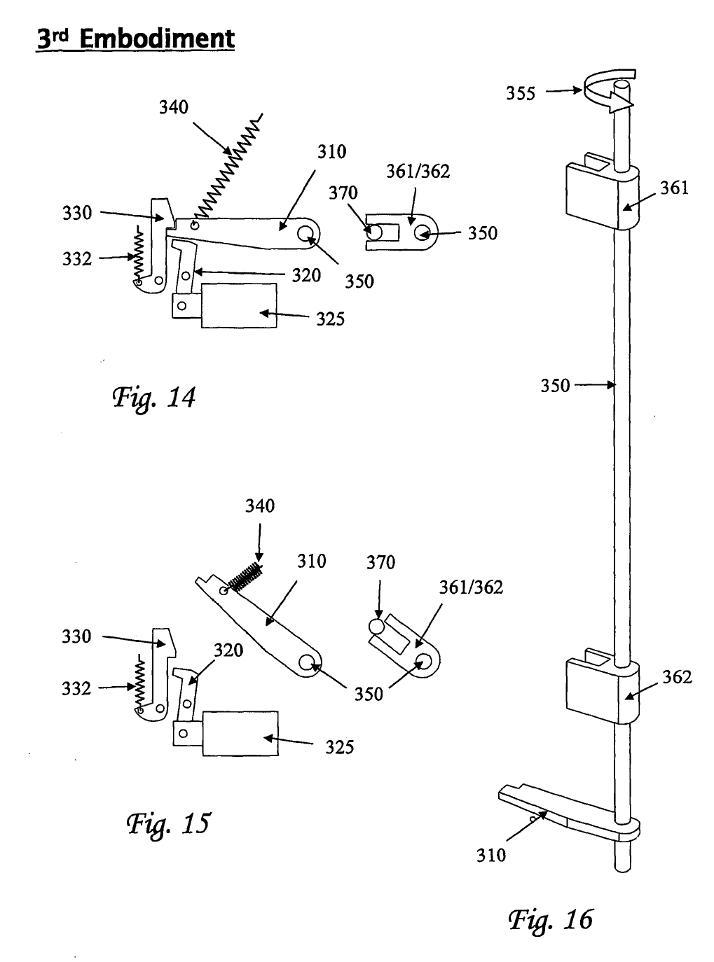

FIGS. 14 to 17 illustrate an electric lock 300 with hammer 320 according to a third embodiment of the present invention. FIG. 14 depicts said electric lock 300 in a locked position, and FIG. 15 depicts the same lock 300 in an unlocked position.

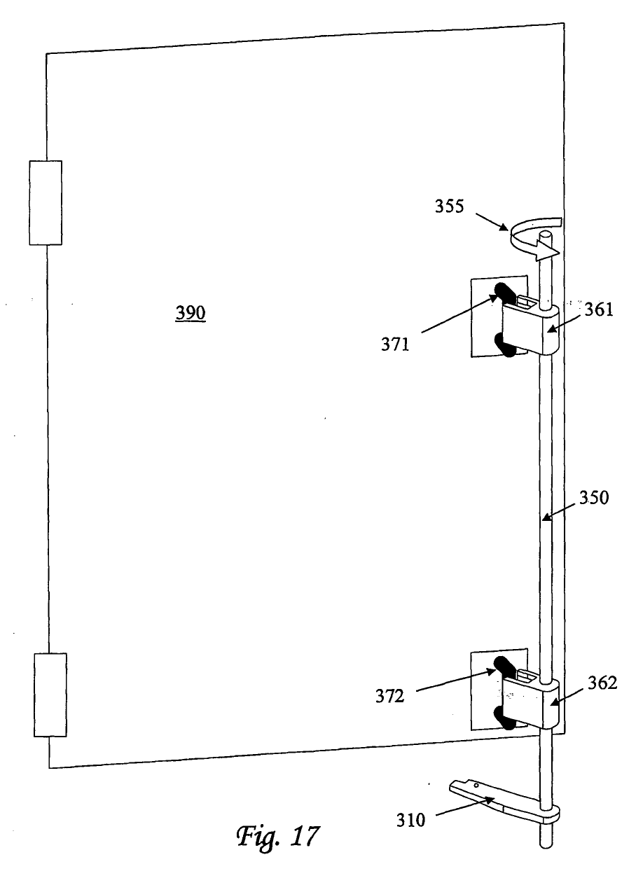

In reference to FIG. 17, when closing door 390, cams 371 and 372 enter the gap of latches 361 and 362, respectively. Said latches are assembled on axis rod 350 along with locking lever 310 as shown in FIG. 16. When the door 390 is pushed to lock, latches 361 and 362 turn axis rod 350 in direction 355 which in turn turns also locking lever 310.

FIG. 15 depicts lock 300 in an unlocked position, just when the door 390 cams 370 meet latches 361 and 362, as shown also in FIG. 17.

In a locking operation, illustrated in FIG. 14, cam 370 enters latches 361 and 362 which in turn turns axis rod 350 which in turn turns locking lever 310 which moves while loading spring 340. When locking lever 310 reaches locking latch 330 it is pushed back against spring 332. When locking lever 310 passes beyond the VAV of locking latch 330 it is pushed forward by spring 332 locking latch 330 and locking lever 310 lock each other. Electric lock 300 is now locked.

To unlock the electric lock 300 with hammer 320 according to a third embodiment of the present invention, illustrated in FIG. 15, solenoid 325 activates hammer 320 while applying most of the energy over a relatively short period of time. Hammer 320 in turn hits locking latch 330 out of its locking position with locking lever 310. Spring 340 pulls locking lever 310 backwards and the door opens up as axis rod 350 turns to move latches 361 and 362. According to the present invention, when mechanical pressure is applied upon any of lock 300 mechanical components, the hammer 320 strikes at latch 330 repeatedly until it releases locking lever 310 and lock 300 unlocks. When locking lever 310 unlocks, it will also cause the circuitry to stop actuating solenoid 325.

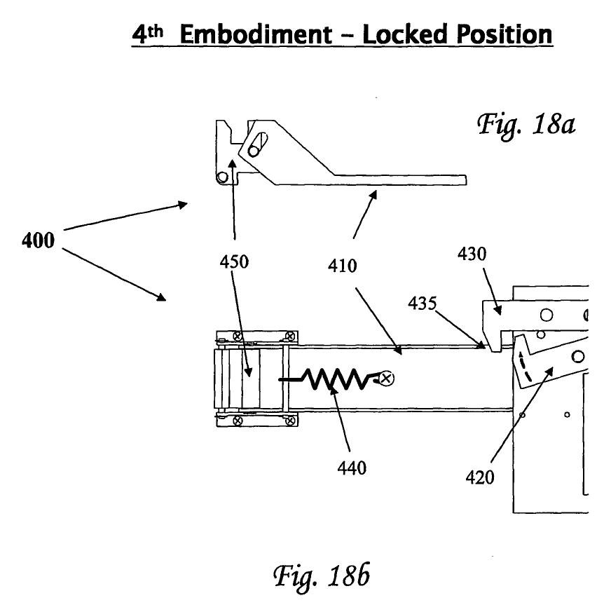

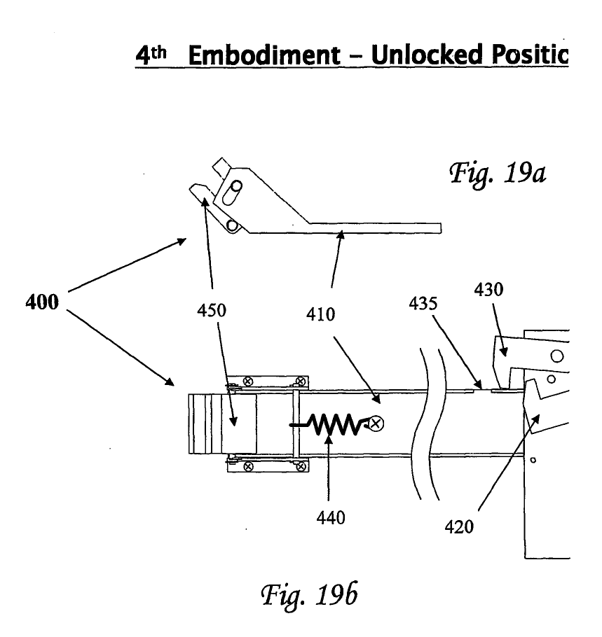

FIGS. 18a and 18b depict an electric lock 400 with hammer 420 according to a fourth embodiment of the present invention in locked position, and FIGS. 19a and 19b depict the same lock 400 in unlocked position.

To close the electric lock 400 with hammer 420 according to the present invention, bar 410 moves forward and door latch 450 closes upon a corresponding bolt. When moving forward, bar 410 stretches spring 440 into a tense state. Latch 430 drops into groove 435 and mechanically locks bar 410. Solenoid 425 and hammer 420 are not active in the locking procedure.

To unlock the electric lock 400 with hammer 420 according to the present invention, the solenoid 425 activates hammer 420 while applying most of the energy over a relatively short period of time. Hammer 420 in turn hits latch 430 out of its groove 435 to unlock said electric lock 400. Spring 440 unloads and pulls bar 410 backwards and door latch 450 opens up. According to the present invention, when mechanical pressure is applied upon any of lock 400 mechanical components, the hammer 420 strikes at latch 430 repeatedly until it comes out of its groove 435 and lock 400 unlocks. When latch 430 comes out of its groove 435, it will also cause the circuitry to stop actuating solenoid 425.

An appropriate electrical circuitry will keep solenoid 425 pushing hammer 420 at a preset interval. Hammer 420 will keep hitting latch/bolt 430 until it comes out of its groove 435, which will cause the circuitry to stop actuating solenoid 425.

The electric locks 100, 200, 300 and 400 with hammer 120, 220, 320 and 420 respectively, according to the present invention, are given as an illustrative example only and not limitation. It can be implemented on many other electric lock with solenoids and hammers to include the electric circuitry to repeatedly supplying the solenoid with electric signal until said lock unlocks.

The electric locks 100-400, according to the present invention, also comprise override mechanism for mechanical unlocking of said locks. FIGS. 8 and 13 exemplify such a mechanism for electric locks 100 and 200 with hammer 120 and 220 respectively, according to the first and second embodiments of the present invention, and will be described in terms of the first embodiments but apply to the second embodiment just the same. Cam 106 can be mechanically rotated. When turned, groove 135 no longer opposes latch 130 which can no longer hold cam 106. Spring 140 unloads and pushes cam 106 backwards and door opens up. This feature can optionally be used for a mechanical override if used with an additional mechanical lock. In similar mechanisms, locking latch 130 can be moved backwards to release locking lever 310 in the third embodiment.

The invention being thus described in terms of several embodiments and examples, it will be obvious that the same may be varied in many ways. Such variations are not to be regarded as a departure from the spirit and scope of the invention, and all such modifications as would be obvious to one skilled in the art, are intended to be included within the scope of the following claims.

What is claimed is:

1. An electric lock comprising:
a solenoid;
a hammer;
a cam unit;
a latch or bolt and corresponding groove, and
a spring or any other pulling means, hydraulic or pneumatic
Wherein the electric lock has a cam with a latch and corresponding groove attached to a door or to any device that is used for closing or opening a closed space or container.
Wherein said solenoid, when unlocking said lock, actuates said hammer which repeatedly hits said latch/bolt out of its corresponding groove, at preset intervals, until said latch/bolt comes out of its corresponding groove. When latch comes out of its groove, it causes circuitry to stop actuating solenoid.
Wherein to close the electric lock, a mechanical force such as a spring or hydraulic or pneumatic or any other force is uploaded into a loaded state, the latch drops into its corresponding groove and mechanically locks the lock.

2. The electric lock according to claim 1 further comprising mechanical means for opening said lock.

3. An electric lock according to claim 1 further comprising:
a hammer;
a solenoid with a plunger;
a spring or any other pulling means, hydraulic or pneumatic
a latch or bolt and corresponding groove;
a cam unit;
Wherein to perform a locking operation, the cam enters the cavity and pushes against a physical force such as a loading spring or any other pulling means, hydraulic or pneumatic, when groove reaches a position opposite the latch, the latch drops into said groove, disallowing cam to go back out and thus locking it.
Wherein to perform an unlocking operation said plunger of solenoid, with hammer, actuates said hammer that hits latch/bolt out of its corresponding groove, at preset intervals, until said latch/bolt comes out of its corresponding groove, a spring or any other pulling means, hydraulic or pneumatic unloads and pushes cam backwards for unlocking. When latch comes out of its groove, it causes circuitry to stop actuating solenoid.

4. The electric lock according to claim 3 further comprising mechanical means for opening said lock.

5. An electric lock according to claim 1 further comprising:
a hammer;
a solenoid;
springs or any other pulling means, hydraulic or pneumatic
door latches or bolts and corresponding groove;
a cam unit;
a locking lever
an axis rod
Wherein to perform a locking operation, cam enters latches, the latches turn axis rod and locking lever accordingly loading the spring or any other pulling means, hydraulic or pneumatic. When locking lever reaches locking latch it is pushed back against the spring, or any other pulling means hydraulic or pneumatic, attached to it; when the locking lever passes beyond its VAV, it is pushed forward by its spring or any other pulling means hydraulic or pneumatic, locking lever and locking latch lock each other.
Wherein to perform an unlocking operation, solenoid activates the hammer, the hammer in turn hits the latch out of its locking position with locking lever. The spring or any other pulling means attached to locking lever pulls locking lever backwards and the door opens up as axis rod turns to move the latches. When locking lever unlocks it causes the circuitry to stop actuating solenoid.

6. The electric lock according to claim 5 further comprising mechanical means for opening said lock.

7. An electric lock according to claim 1 further comprising:
a hammer;
a solenoid;
a bar with means for pulling it back;
a cam unit,
door latch and corresponding groove;
a bolt
spring or any other pulling means
Wherein to perform a locking operation, the bar moves forward, stretches spring into a tense state, door latch drops into groove and mechanically locks bar, closing a corresponding bolt.
Wherein to perform an unlocking operation, the solenoid activates hammer, hammer hits latch out of its groove, the spring unloads and pulls bar backwards and door latch opens up. When latch comes out of its groove, it causes circuitry to stop actuating solenoid.

8. The electric lock according to claim 7 further comprising mechanical means for opening said lock.
